(19) United States
(12) Patent Application Publication
(10) Pub. No.: US 2014/0069013 A1
(43) Pub. Date: Mar. 13, 2014

(54) REMOTE CONTROLLED AUTOMATIC DOOR CLOSER

(71) Applicant: Pamela Wilson, Altadena, CA (US)

(72) Inventor: Pamela Wilson, Altadena, CA (US)

(21) Appl. No.: 13/614,926

(22) Filed: Sep. 13, 2012

(51) Int. Cl. E05F 15/20

(52) U.S. Cl. 49/25

(57) ABSTRACT

A door closer system includes a base housing configured to couple to a mounting point. A top housing movably couples to the base housing, where the top housing is configured to travel in a linear motion between a extended position and a compressed position relative to the base housing. A linear actuator couples to the base housing and the top housing. A spring couples to the base housing and the top housing. A locking mechanism couples to the base housing and the top housing. A controller couples to the base housing and the linear actuator. A wireless receiver couples to the base housing and the controller. A remote controller includes a user interface and a wireless transmitter.

### BACKGROUND OF THE INVENTION

1. Field of the Invention

The present invention relates to automatic door operators, and more specifically, to an automatic door closer that may be activated via a remote controller.

2. Description of the Related Art

There are a number of situations where remotely controlled automatic door closers are desirable. In an office environment, a professional may need to close an office door for privacy or to reduce noise without disrupting work to get up, walk to the door, and physically close it.

Devices for automatically closing a door are well known. In some examples, they include an actuator which controls an electrical motor and a radius arm that extends out to the door to transmit a closing force to the door. In other examples, doors biased to a closed position by a spring or pneumatic device may be held opened by a latch which can be remotely released to allow the door to close. Most of these devices require that a drive mechanism for operating the door be physically attached to the door and a wall or door frame. They typically require extensive modifications to a door or to its frame or adjacent walls in order to be later added or removed. None of these disclosures, either individually or in combination, discloses the features of the present invention as claimed.

It is desirable to provide a remote controlled automatic door closer that avoids the foregoing disadvantages of known devices. It is to these ends the present invention is directed.

### BRIEF SUMMARY OF THE INVENTION

Accordingly, the present invention provides for an effective device which is capable of closing a door via command from a remote controller. The present invention saves user time in manually closing a door and also avoids complex and time consuming installation and removal.

A door closer system includes a base housing configured to couple to a mounting point. A top housing movably couples to the base housing, where the top housing is configured to travel in a linear motion between a extended position and a compressed position relative to the base housing. A linear actuator couples to the base housing and the top housing. A spring couples to the base housing and the top housing. A locking mechanism couples to the base housing and the top housing. A controller couples to the base housing and the linear actuator. A wireless receiver couples to the base housing and the controller. A remote controller includes a user interface and a wireless transmitter.

These and other aspects of the present invention will become more fully understood upon further review of the following specifications and accompanying drawings.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a portion of a door closer system in accordance with an embodiment of the present invention;

FIG. 2 illustrates a portion of a door closer system in accordance with a first embodiment of the present invention;

FIG. 3 illustrates a flow chart of a method of remotely closing a door in accordance with a first embodiment of the present invention;

FIG. 4 illustrates a portion of a door closer system in accordance with a second embodiment of the present invention;

FIG. 5 illustrates a flow chart of a method of remotely closing a door in accordance with a second embodiment of the present invention;

FIG. 6 illustrates a portion of a door closer system in accordance with a third embodiment of the present invention;

FIG. 7 illustrates a flow chart of a method of remotely closing a door in accordance with a third embodiment of the present invention; and

FIG. 8 illustrates the use of a door closer system in accordance with an embodiment of the present invention.

### DETAILED DESCRIPTION

A door closer system will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the true scope of the invention.

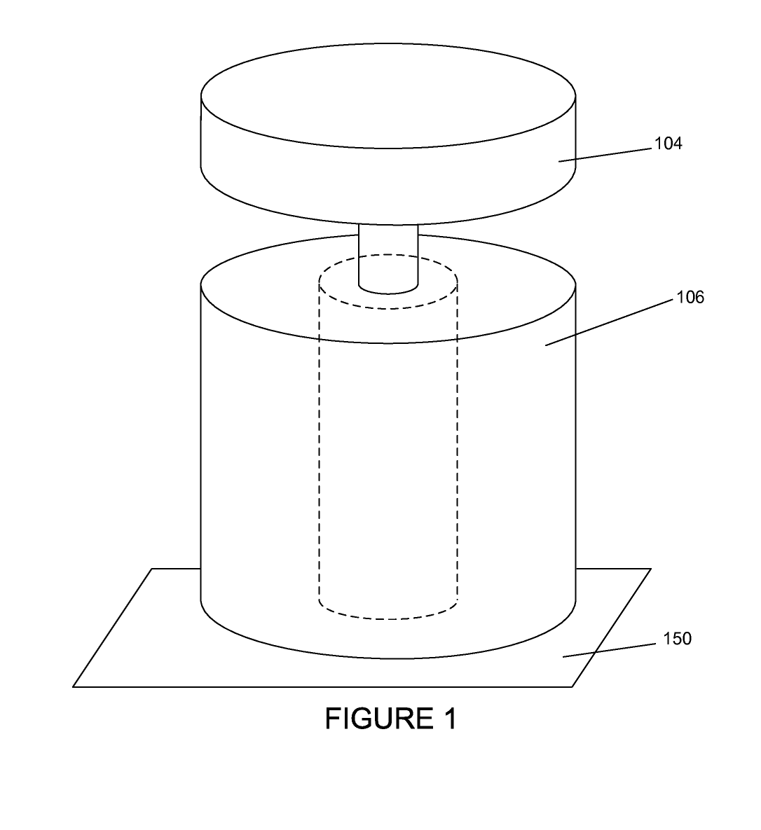

FIG. 1 illustrates a portion of a door closer system in accordance with an embodiment of the present invention. In some exemplary embodiments of a door closer system, a base housing 106 is configured to couple to a mounting point 150. The base housing 106 may be any enclosure that provides structure and support to components enclosed by the base housing 106 and components coupled to the base housing 106. The base housing 106 may comprise materials such as plastic, metal, or ceramic.

A top housing 104 is movably coupled to the base housing 106. The top housing 104 may be any enclosure that provides structure and support to components enclosed by the top housing 104 and components coupled to the top housing 104. The base housing 106 may comprise materials such as plastic, metal, or ceramic. The top housing 104 is configured to travel in a linear motion between an extended position and a compressed position relative to the base housing 106. Ideally, the line of travel between the extended position and the compressed position is approximately perpendicular to a surface of the door. The door in its fully opened position should be in contact with the top housing 104 in the compressed position. The top housing 104, traveling from the compressed position to the extended position, should remain in contact with the door until it reaches the extended position. This constant contact while traveling from the compressed position to the extended position gives the door a push from the door's fully opened position towards closing the door. Ideally, momentum generated in the door from the push will carry the door to a closed position. Typically, a linear distance between the extended position and the compressed position is between 5 mm and 100 mm. A longer linear distance is more suitable for doors with a higher mass as it typically allows for a greater amount of momentum to be transferred from the top housing 104 to the door. However, a longer linear distance also requires a larger housing base.

In some embodiments of a door closer system, a cushion is coupled to the top housing 104. The cushion acts as a physical buffer between the top housing 104 and the door to reduce or eliminate noise and damage from the top housing 104 pushing against the door.

The door closing device functions optimally in closing the door if the door's initial position is in contact with the top housing 104 in the compressed position. The performance of the door closer system is degraded in situations where a user does not take care in placing the door in the fully opened position so that the door is in contact with the top housing 104 in the compressed position. In some embodiments of a door closer system, a first magnetic pad is coupled to the top housing 104 and a second magnetic pad is coupled to the door. The first magnetic pad and the second magnetic pad are magnetically attracted to one another and are magnetically coupled when the door is in a fully opened position. Thus, the addition of the first magnetic pad and the second magnetic pad allows the user to more easily place the door in the fully opened position in contact the top housing 104 in the compressed position. The first magnetic pad and the second magnetic pad also functions to keep the door in the fully opened position and in contact with the top housing 104 until a separating force is applied to separate the top housing 104 from the door. The separating force is caused by the momentum of the door immediately after being pushed by the top housing 104 traveling from the compressed position to the extended position.

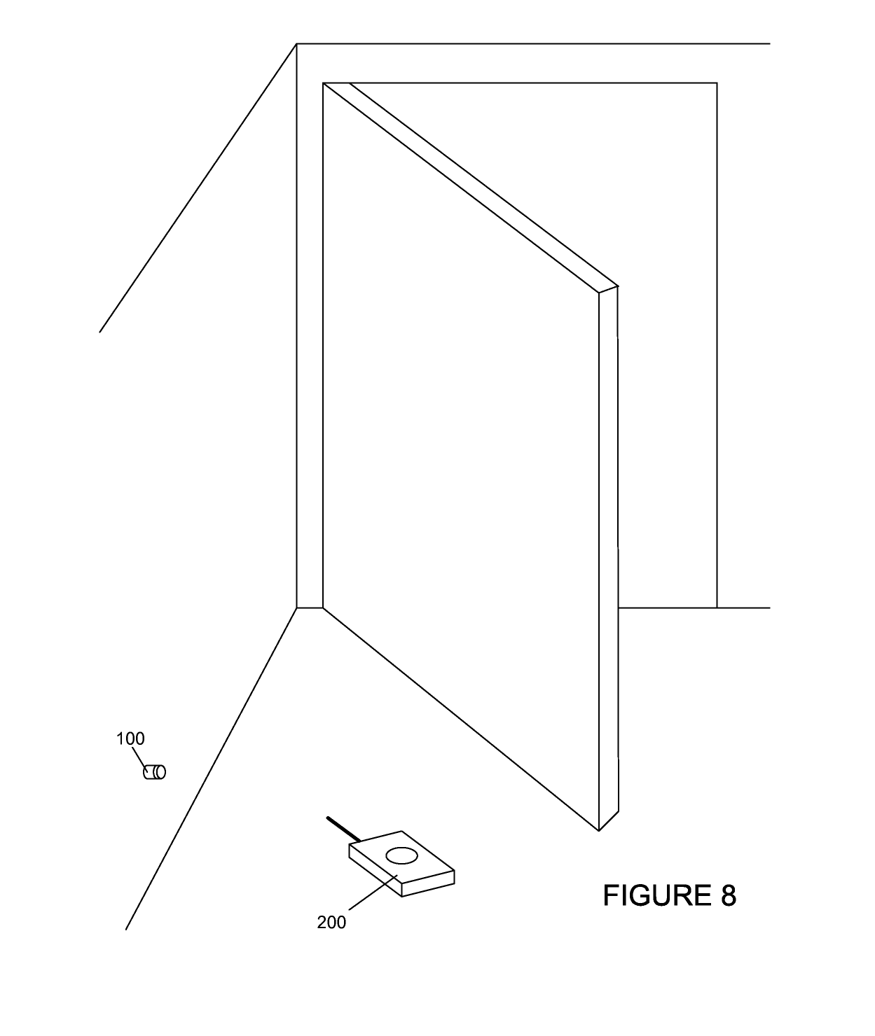

FIG. 8 illustrates the use of a door closer system in accordance with an embodiment of the present invention. The mounting point 150 is typically attached to an area on a wall or floor against which a door in its fully opened position may rest against. Often, the mounting point 150 may be on an existing door stopper or on any area where a door stopper would typically be installed. The ideal position for the mounting point 150 is anywhere that is aesthetically pleasing, visually not distractive, and provides a high amount of mechanical advantage against an opened door. In terms of height, the mounting point 150 may be any height between the ground and the height of the door.

Alternatively, the mounting point 150 may be attached to the door instead of the wall or the floor. In some embodiments of a door closer system, the housing base 106 is coupled to a mounting point on the door. The door in its fully opened position places the wall in contact with the top housing 104 in the compressed position. In this alternative embodiment, the top housing 104 pushes against the wall instead of the door to push the door to the closed position.

A wireless receiver 200 is coupled to the base housing 106. In some exemplary embodiments of a door closer system, the wireless receiver may be enclosed by the base housing 106. In some embodiments, a controller may be coupled to and enclosed by the base housing 106. The controller functions to cause the top housing 104 to move from the compressed position to the extended position when a close door signal is received by the wireless receiver from a remote controller 200.

The remote controller 200 includes a user interface and a wireless transmitter. In some embodiments, the remote controller 200 may be a stand-alone device such as a handheld remote control or a push button device mounted to a table. In some other embodiments, the remote controller 200 may be a multiple function device such as a mobile phone, computer tablet, or personal computer, adopted for use as a remote controller 200. The user interface may be any interface that allows a user to input a door closing command. In some embodiments, the user interface may be a single button on a handheld remote, an on-screen button on a touch screen device, or an on-screen button to be selected with a mouse. The wireless transmitter transmits the close door signal to the wireless receiver when the user inputs a door closing command on the user interface. In some embodiments, the wireless transmitter communicates to the wireless receiver by radio frequency signal, infra red signal, Bluetooth network signal, or WIFI network signal.

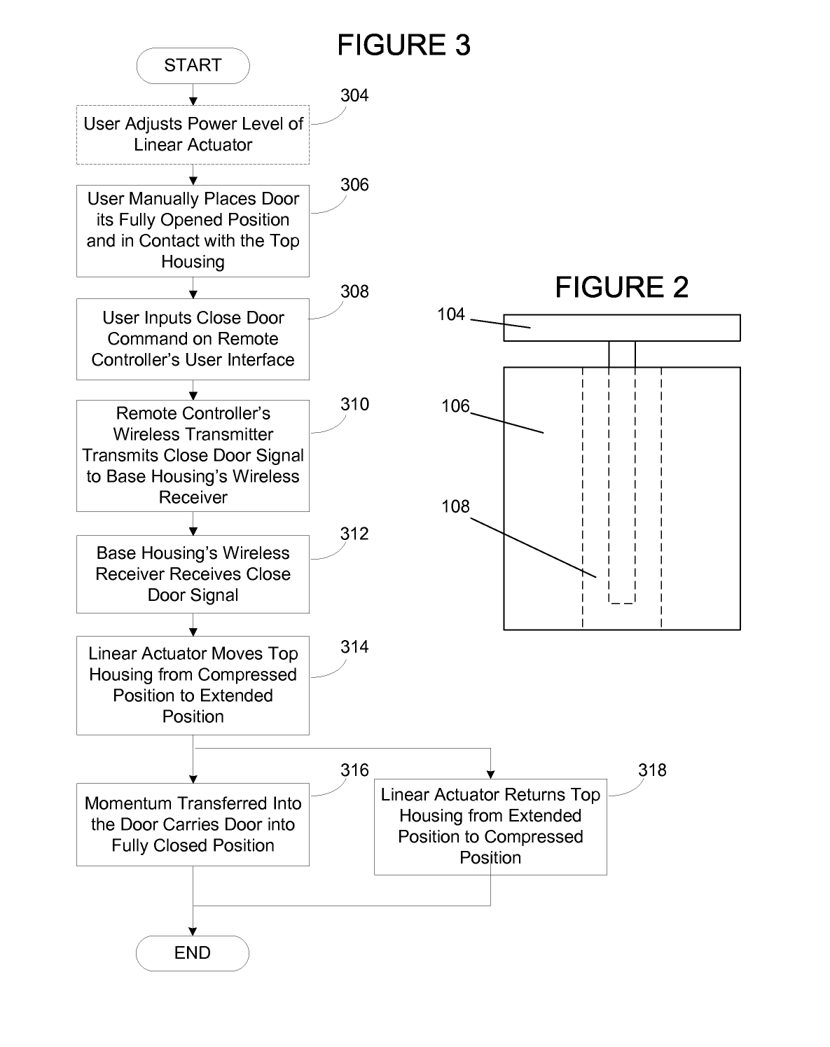

FIG. 2 illustrates a portion of a door closer system in accordance with a first embodiment of the present invention. A linear actuator 108 is coupled to the base housing 106 and the top housing 104. The linear actuator 108 may be enclosed by the base housing 106. As well known in the art, the linear actuator 108 may be any device that creates motion in a straight line such as electro-mechanical actuator, linear motor, hydraulic actuator, or pneumatic actuator. Due to their compactness and the accessibility of electrical power, electro-mechanical actuators and linear motors are foreseen as most suitable for door closing applications. An exemplary linear actuator 108 is a screw type electro-mechanical actuator that converts rotational motion from a standard electric motor into linear motion. The screw type electro-mechanical actuators are versatile and can be used in either high speed or high force applications. In a screw type electro-mechanical actuator, an electrical motor turns a screw which pulls the screw through a thread with a linear motion. A different example of a linear actuator 108 is a linear motor that includes a permanent magnetic field and a coil winding that produces a force proportional to the current applied to the coil winding. Linear motors are generally more energy efficient, reliable, and compact than electro-mechanical actuators but are lacking in high force applications.

The linear actuator 108 functions to move the top housing 104 from the compressed position to the extended position, which in turns pushes a fully opened door towards the closed position. In some embodiments, the linear actuator 108 may also return the top housing 104 back to the compressed position from the extended position. In some embodiments, the linear actuator 108 may receive power from a cable leading to an electrical wall plug or a cable leading to a battery source within the housing base. In some embodiments, the linear actuator 108 may be adjusted in power level based on the door. A heavier door or a door with a more resistant hinge requires a correspondingly higher power level for the linear actuator 108.

FIG. 3 illustrates a flow chart of a method of remotely closing a door in accordance with the first embodiment of the present invention. The user first adjusts the power level of the linear actuator 108, 304. The user then manually places the door in its fully opened position in contact with the top housing 104, 306. The user then inputs a close door command on the remote controller 200's user interface, 308. The remote controller 200 then transmits the close door signal to the base housing 106's wireless receiver, 310. The base housing 106's wireless receiver then receives the close door signal, 312. The linear actuator 108 then moves the top housing 104 from the compressed position to the extended position, 314. Momentum transferred into the door then carries the door into its fully closed position, 316. The linear actuator 108 returns the top housing 104 to from the extended position to the compressed position, 318.

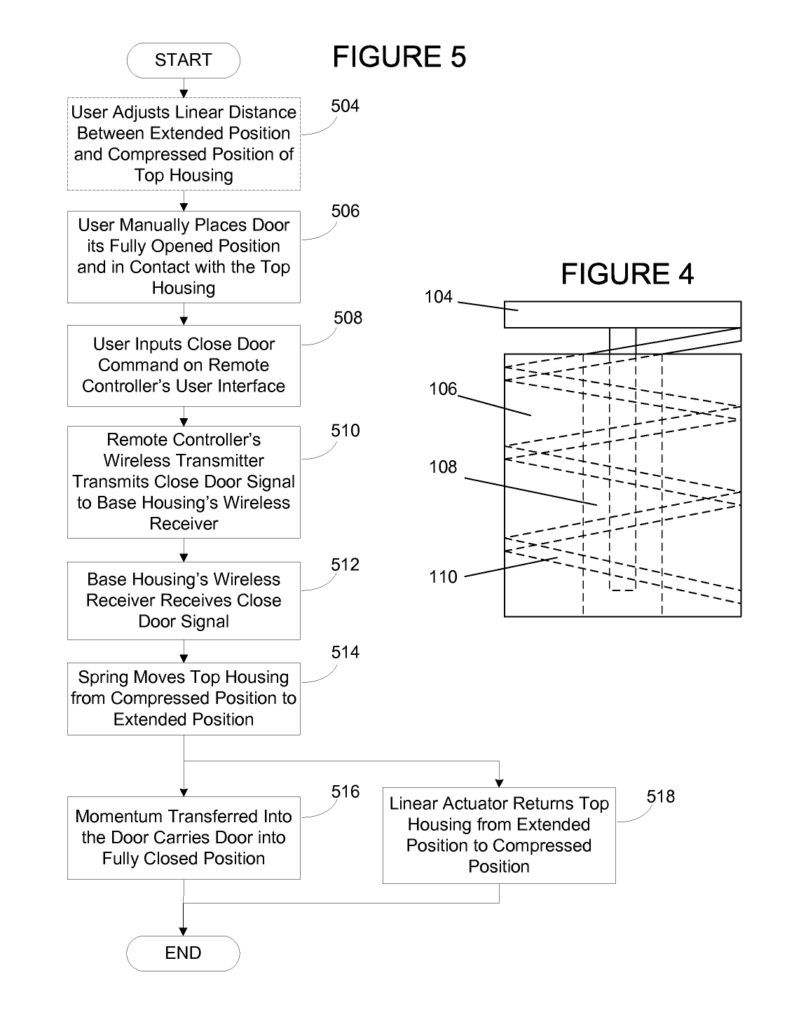

FIG. 4 illustrates a portion of a door closer system in accordance with a second embodiment of the present invention. This second embodiment differs from the first embodiment in that a spring 110 couples to the base housing 106 and the top housing 104. The spring 110, instead of the linear actuator 108, functions to move the top housing 104 from the compressed position to the extended position, which in turn pushes a fully opened door toward the closed position. The spring 110 in a compressed spring position corresponds to the top housing 104 in the compressed position. The spring 110 in an extended spring position corresponds to the top housing 104 in the extended position. A spring 110 is preferable over a linear actuator 108 for pushing the top housing 104 from the compressed position to the extended position in situations where a linear actuator 108 lacks the necessary power to push the door into the fully closed position. The linear actuator 108 instead functions to compress the spring 110 from the extended spring position to the compressed spring position to return the top housing 104 from the extended position to the compressed position.

In some embodiments, the linear distance may be adjusted in length based on the door. A longer linear distance allows the spring 110 a great amount of compression and travel which in turn transfers more momentum into the door. A heavier door or a door with a more resistant hinge requires a correspondingly longer linear distance.

Additionally, a locking mechanism couples to the base housing 106 and the top housing 104. The locking mechanism functions to hold the spring 110 in the compressed spring position and the top housing 104 in the compressed position until the user commands the door to close. In some embodiments, the locking mechanism is configured to maintain the top housing 104 in the compressed position until an unlocking actuator is activated by the remote controller 200. These locking mechanisms with an unlocking actuator are well known in the art.

FIG. 5 illustrates a flow chart of a method of remotely closing a door in accordance with the second embodiment of the present invention. The user first adjusts the linear distance between the extended position and the compressed position of the top housing, 504. The user then manually places the door in its fully opened position in contact with the top housing 104, 506. The user then inputs a close door command on the remote controller 200's user interface, 508. The remote controller 200 then transmits the close door signal to the base housing 106's wireless receiver, 510. The base housing 106's wireless receiver then receives the close door signal, 512. The spring 110 from the compressed spring position to the extended spring position then moves the top housing 104 from the compressed position to the extended position, 514. Momentum transferred into the door then carries the door into its fully closed position, 516. The linear actuator 108 returns the top housing 104 to from the extended position to the compressed position and compresses the spring 110, 518.

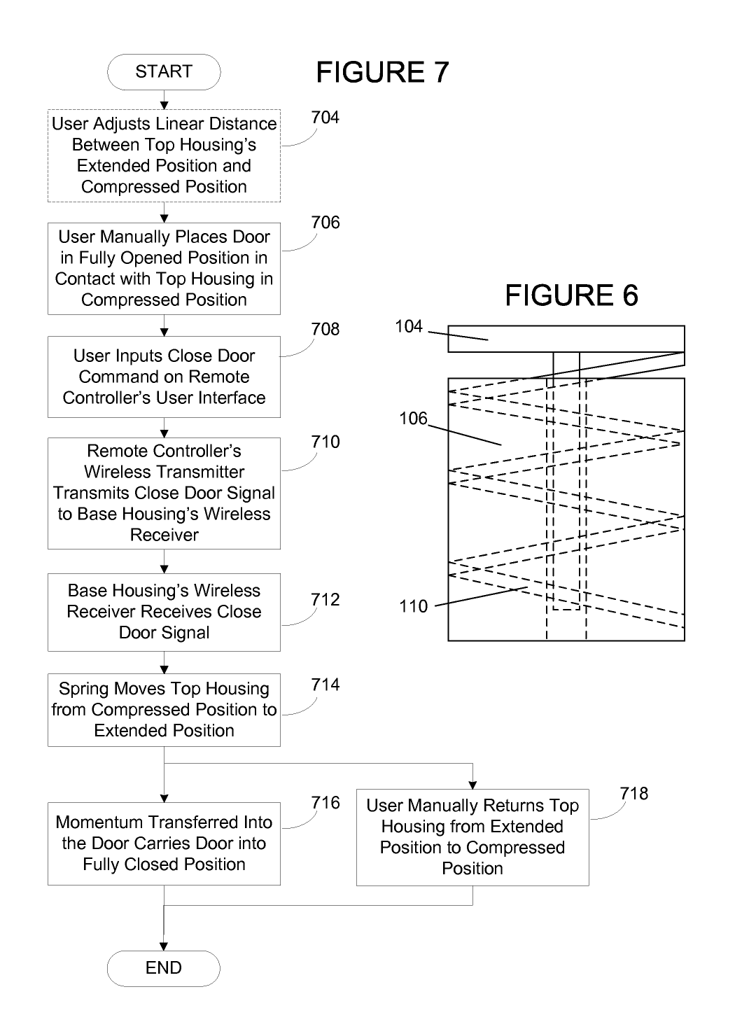

FIG. 6 illustrates a door closer system in accordance with a third embodiment of the present invention. This third embodiment differs from the second embodiment in that the linear actuator 108 and its associated power source may be eliminated. Like the second embodiment, the spring 110 functions to move the top housing 104 from the compressed position to the extended position, which in turn pushes a fully opened door toward the closed position. Instead of using a linear actuator 108, the user may manually compress the spring 110 from the extended spring position to the compressed spring position. The user may wish to manually press the door into the top housing 104 to compress the spring 110 from the extended spring position to the compressed spring position. This embodiment eliminates the need for a convenient power supply, reduces manufacturing costs, and reduces size.

In some embodiments, the locking mechanism may be a toggle lock configured to maintain the top housing 104 in the compressed position until a triggering compression motion is applied to the top housing 104 against the base housing 106 by the linear actuator 108. These locking mechanisms are well known in the art as they are widely used in common retractable ball-point pens caps. When the top housing 104 starts in the extended position, a first push against the spring 110 locks the top housing 104 in the compressed position. A second push in the same direction as the first push against the spring 110 then unlocks the top housing 104 to allow the spring 110 to push the top housing 104 into the extended position.

FIG. 7 illustrates a flow chart of a method of remotely closing a door in accordance with the third embodiment of the present invention. The user first adjusts the linear distance between the extended position and the compressed position of the top housing 104, 704. The user then manually places the door in its fully opened position in contact with the top housing 104 in the compressed position, 706. The user then inputs a close door command on the remote controller 200's user interface, 708. The remote controller 200 then transmits the close door signal to the base housing 106's wireless receiver, 710. The base housing 106's wireless receiver then receives the close door signal, 712. The spring 110 from the compressed spring position to the extended spring position then moves the top housing 104 from the compressed position to the extended position, 714. Momentum transferred into the door then carries the door into its fully closed position, 716. The user manually returns the top housing 104 to from the extended position to the compressed position and compresses the spring 110, 118.

While the invention herein disclosed has been described by means of specific embodiments and applications thereof, numerous modifications and variations could be made thereto by those skilled in the art without departing from the scope of the invention set forth in the claims.

What is claimed is:

1. A door closer system comprising:
a base housing configured to couple to a mounting point;
a top housing movably coupled to said base housing, wherein said top housing is configured to travel in a linear motion between a extended position and a compressed position relative to said base housing;
a linear actuator coupled to said base housing and said top housing;
a wireless receiver coupled to said base housing; and
a remote controller comprising a user interface and a wireless transmitter.

2. The system of claim 1, wherein said linear actuator comprises a rotary electric motor.

3. The system of claim 1, wherein said linear actuator comprises a linear electric motor.

4. The system of claim 1, wherein said linear actuator comprises a pneumatic actuator.

5. The system of claim 1, additionally comprising a cushion coupled to said top housing.

6. The system of claim 1, additionally comprising a first magnetic pad coupled to said top housing and a second magnetic pad coupled to a door, wherein said first magnetic pad magnetically couples to said second magnetic pad when said door is in a fully opened position.

7. The system of claim 1, wherein said linear actuator is configured to move said top housing from said compressed position to said extended position then back to said compressed position upon said remote controller transmitting an activation signal to said wireless receiver.

8. A door closer system comprising:
a base housing configured to couple to a mounting point;
a top housing movably coupled to said base housing, wherein said top housing is configured to travel in a linear motion between a extended position and a compressed position relative to said base housing;
a linear actuator coupled to said base housing and said top housing, wherein said linear actuator is configured to move said top housing from said extended position to said compressed position;
a spring coupled to said base housing and said top housing;
a locking mechanism coupled to said base housing and said top housing;
a wireless receiver coupled to said base housing; and
a remote controller comprising a user interface and a wireless transmitter.

9. The system of claim 8, wherein said linear actuator comprises a rotary electric motor.

10. The system of claim 8, wherein said linear actuator comprises a linear electric motor.

11. The system of claim 8, wherein said linear actuator comprises a pneumatic actuator.

12. The system of claim 8, wherein said locking mechanism is a toggle lock configured to maintain said top housing in said compressed position until a triggering compression motion is applied to said top housing against said base housing by said linear actuator.

13. The system of claim 8, wherein said locking mechanism is configured to maintain said top housing in said compressed position until an unlocking actuator is activated by said remote controller.

14. The system of claim 8, additionally comprising a first magnetic pad coupled to said top housing and a second magnetic pad coupled to a door, wherein said first magnetic pad magnetically couples to said second magnetic pad when said door is in a fully opened position.

15. A door closer system comprising:
a base housing configured to couple to a mounting point;
a top housing movably coupled to said base housing, wherein said top housing is configured to travel in a linear motion between a extended position and a compressed position relative to said base housing;
a spring coupled to said base housing and said top housing;
a locking mechanism coupled to said base housing and said top housing, wherein said locking mechanism is configured to maintain said top housing in said compressed position until an unlocking actuator is activated by said remote controller;
a wireless receiver coupled to said base housing; and
a remote controller comprising a user interface and a wireless transmitter.

16. The system of claim 15, wherein said locking mechanism is a toggle lock configured to maintain said top housing in said compressed position until a triggering compression motion is applied to said top housing against said base housing by said linear actuator.

17. The system of claim 15, wherein said locking mechanism is configured to maintain said top housing in said compressed position until an unlocking actuator is activated by said remote controller.

18. The system of claim 15, additionally comprising a first magnetic pad coupled to said top housing and a second magnetic pad coupled to a door, wherein said first magnetic pad magnetically couples to said second magnetic pad when said door is in a fully opened position.
